(19) United States
(12) Patent Application Publication
(10) Pub. No.: US 2008/0083163 A1
(43) Pub. Date: Apr. 10, 2008

(54) Flowerpot Saucer Apparatus

(76) Inventors: Ofir Amsellem, Haifa (IL); Meir Gitelis, Moshav Bnei Atarot (IL)

Correspondence Address: HAIM FACTOR;Ofek Group Inc., 16192 Coastal Highway, Lewes, DE, 19958, US

(21) Appl. No.: 11/859,811

(22) Filed: Sep. 24, 2007

Related U.S. Application Data
(60) Provisional application No. 60/828,777, filed on Oct. 10, 2006.

(51) Int. Cl. A01G 27/02; A01G 9/02

(52) U.S. Cl. 47/66.6; 47/79

(57) ABSTRACT

In one embodiment, the present invention is directed to a saucer apparatus, comprising: a drainage container, for storing water drained from a soil container; and a conveying mechanism, for conveying the drainage container from a first state in which the drainage container is deployed underneath the soil container, thereby allowing accumulating drained water, and a second state in which the drainage container is deployed apart of the soil container, thereby allowing emptying water stored in the drainage container, and vice versa. The soil container may be is embedded into the apparatus, or comprise means for holding the flowerpot above the apparatus or on the apparatus, such as grill. According to one embodiment of the invention, the conveying mechanism conveys the drainage container linearly.

The current application claims the benefit U.S. Provisional Patent application No. 60/828,777, filed 10 Oct. 2006, whose disclosures are incorporated herein by reference.

### FIELD OF THE INVENTION

The present invention relates to the field of irrigation. More particularly, the invention relates to an apparatus for accumulating water drained from a flowerpot.

### BACKGROUND OF THE INVENTION

A “flowerpot” is any container in which plants are cultivated. Terra cotta is often used in their making. They are also often made from plastic, wood or stone.

Usually there is a small hole in the bottom of a flowerpot, to allow excess water of the flowerpot to drain into a saucer deployed under the flowerpot. It is known that avoiding draining excess water out of a flowerpot results with shortening the life of the flora thereof due to root damage or decay.

Currently “giant” flowerpots are common in office halls, as well as at domestic residences. Despite of the fact that “giant” flowerpots are esthetically appealing, their size is an obstacle since lifting up the saucer underneath a flowerpot in order to remove the saucer requires physical effort due to the weight of the flowerpot. The same problem sustains also for hanging flowerpots.

It is an object of the present invention to provide a saucer apparatus which overcomes the prior art problems described above.

Other objects and advantages of the invention will become apparent as the description proceeds.

### SUMMARY OF THE INVENTION

The following embodiments and aspects thereof are described and illustrated in conjunction with systems, tools and methods, which are meant to be merely illustrative, not limiting in scope. In various embodiments, one or more of the above-described problems have been reduced or eliminated, while other embodiments are directed to other advantages or improvements.

In one embodiment, the present invention is directed to a saucer apparatus, comprising:
a drainage container, for storing water drained from a soil container; and
a conveying mechanism, for conveying the drainage container from a first state in which the drainage container is deployed underneath the soil container, thereby allowing accumulating drained water, and a second state in which the drainage container is deployed apart of the soil container, thereby allowing emptying water stored in the drainage container, and vice versa.

The soil container may be is embedded into the apparatus, or comprise means for holding the flowerpot above the apparatus or on the apparatus, such as grill.

According to one embodiment of the invention, the conveying mechanism conveys the drainage container linearly.

According to another embodiment of the invention, the conveying mechanism conveys the drainage container rotationally.

The conveying mechanism may be based on a drawer conveying technology.

The apparatus may further comprise a water level sensor, for indicating the water level in the drainage container.

The apparatus may further comprise a sensor, for indicating if the water level in the drainage container exceeds a predetermined level.

The apparatus may further comprise a pump, for conveying drained water from the drainage container back into the soil container upon indicating that the water level in the drainage container has exceeded the predetermined level.

The apparatus may further comprise a pump, for conveying drained water from the drainage container back into the soil container. The pump may be operated by mechanical power, electrical power, and so on.

In another aspect, the present invention is directed to a flowerpot irrigation method, the method comprising the steps of:
draining water from a soil container of the flowerpot into a saucer apparatus; and
upon indicating that the water level in the saucer apparatus has reached a predetermined level, conveying water from the saucer apparatus into the soil container.

The predetermined level may indicate that the saucer apparatus is substantially empty, substantially full, and so on, depending on the level.

According to one embodiment of the invention, the act of conveying water from said saucer apparatus into said soil container may be carried out intermittently, i.e., once in a time period, such as once in two days.

In addition to the exemplary aspects and embodiments described above, further aspects and embodiments will become apparent by reference to the figures and by study of the following detailed description.

### BRIEF DESCRIPTION OF THE DRAWINGS

The objects and features of the present invention will become apparent from the following detailed description considered in conjunction with the accompanying drawings, in which:

Each of FIGS. 1a and 1b schematically illustrates a flowerpot in which is embedded a saucer apparatus, according to one preferred embodiment of the invention.

FIG. 2 illustrates a “circular” flowerpot 6 placed on a saucer apparatus 8, according to an embodiment of the present invention.

FIG. 3 illustrates a “rectangular” flowerpot 6 placed on a saucer apparatus 8, according to another embodiment of the present invention.

FIG. 4 is a sectional and exploded view of the flowerpot 6 and the saucer 8 of FIG. 2.

FIG. 5 is a back view of saucer apparatus 8, according to one embodiment of the invention, and FIG. 6 is the front view thereof.

FIG. 7 schematically illustrates a circuit for an irrigation system which makes use of a saucer apparatus, according to one embodiment of the invention.

FIG. 8 illustrates a manual mechanism for recycling irrigation water from a saucer apparatus, according to one embodiment of the invention.

FIG. 9 is a cross-section which illustrates the structure of the mechanism illustrated in FIG. 8.

FIG. 10 schematically illustrates the lower side of a flowerpot, according to one embodiment of the invention, and FIG. 11 is a sectional view thereof.

Each of FIGS. 12a and 12b schematically illustrates a state of the drainage container of a flowerpot, according to another preferred embodiment of the invention.

It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein. Reference numerals may be repeated among the figures to indicate corresponding or analogous elements.

### DETAILED DESCRIPTION OF PREFERRED EMBODIMENTS

In the following detailed description, numerous specific details are set forth in order to provide a thorough understanding of the disclosure. However, it will be understood by those skilled in the art that the present invention may be practiced without these specific details. In other instances, well-known methods, procedures, components and circuits have not been described in detail, so as not to obscure the present disclosure.

Each of FIGS. 1a and 1b schematically illustrates a flowerpot in which is embedded a saucer apparatus, according to one preferred embodiment of the invention. In FIG. 1a the flowerpot has a circular contour, while in FIG. 1b it has a rectangular contour.

Each of these figures illustrates a flowerpot 6, in which a plant 4 is planted for cultivation. Saucer apparatus 8, which accumulates water drained from flowerpot 6, comprises a container 10 adapted to be pulled out/pushed in, as in a drawer mechanism. A handle 22 connected to drawer (container) 10 is used for pulling container 10 out of flowerpot 6.

Further to the esthetical advantage of employing a drawer as a container for accumulating drained water, this solution also spares the need of pillars to retain the flowerpot above the draining container 10.

It should be notes that in the embodiment of FIG. 1b two containers/drawers 10 are employed.

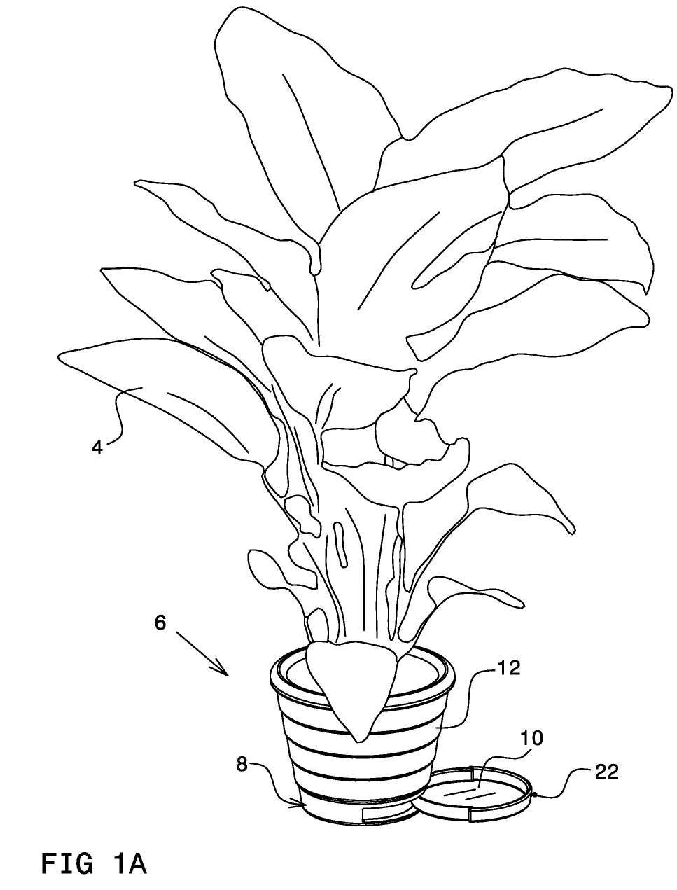

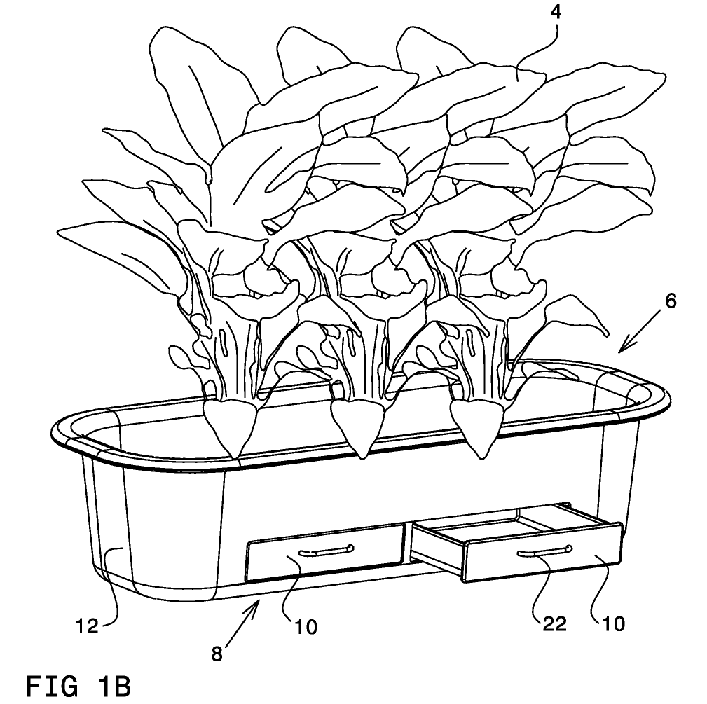

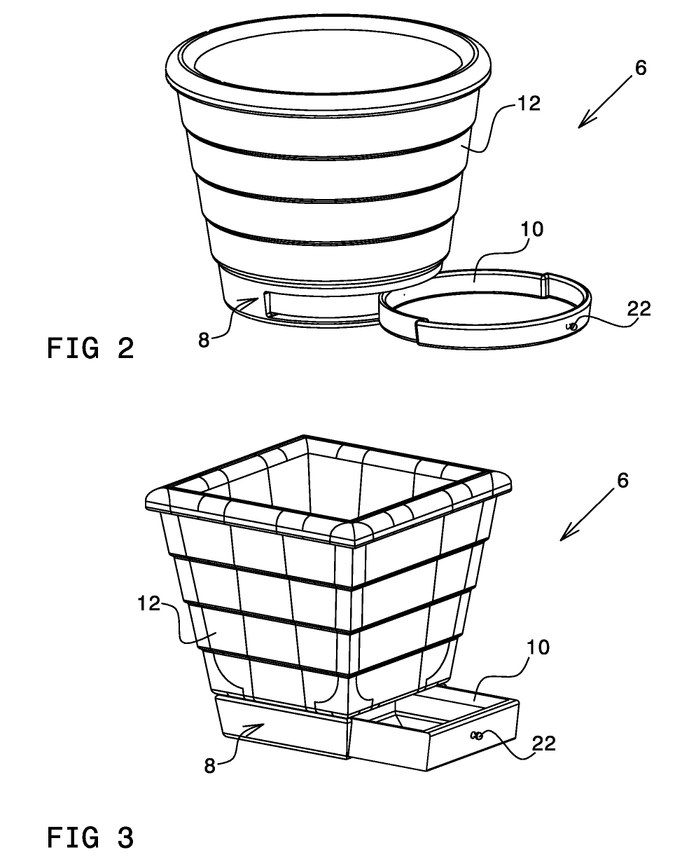

FIG. 2 illustrates a “circular” flowerpot 6 placed on a saucer apparatus 8, according to an embodiment of the present invention.

FIG. 3 illustrates a “rectangular” flowerpot 6 placed on a saucer apparatus 8, according to another embodiment of the present invention.

These illustrations demonstrate that a saucer apparatus 8 may be designed according to the flowerpot thereof. Furthermore, other forms may be employed for the contour, such as elliptic, trapezoid, and so on.

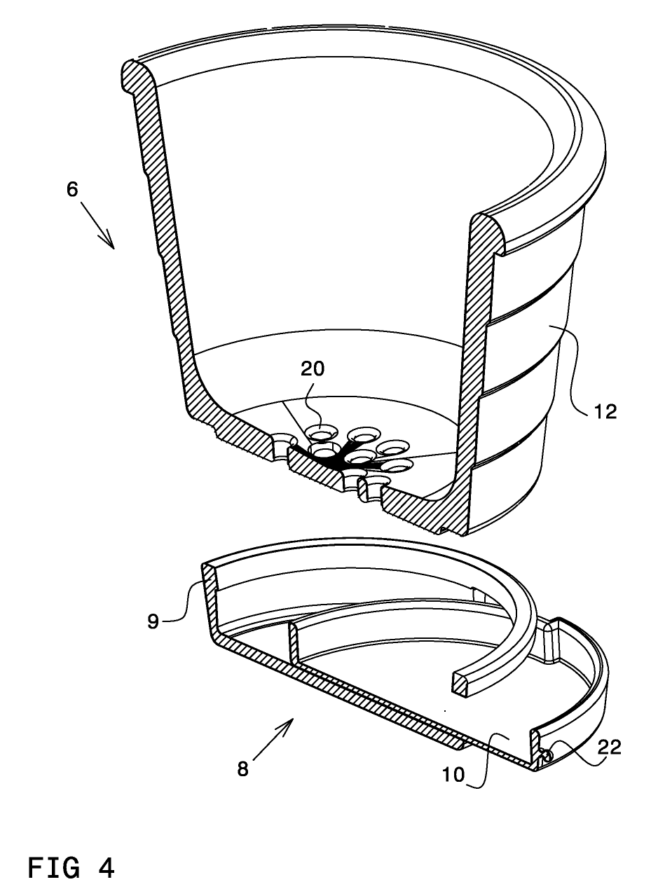

FIG. 4 is a sectional and exploded view of the flowerpot 6 and the saucer 8 of FIG. 2. As illustrated, housing 9 may be a separate part from the flowerpot 12, and therefore the drawer mechanism may be adapted to suit any existing flowerpot, not necessarily one designed especially to comprise a built-in drainage container 10.

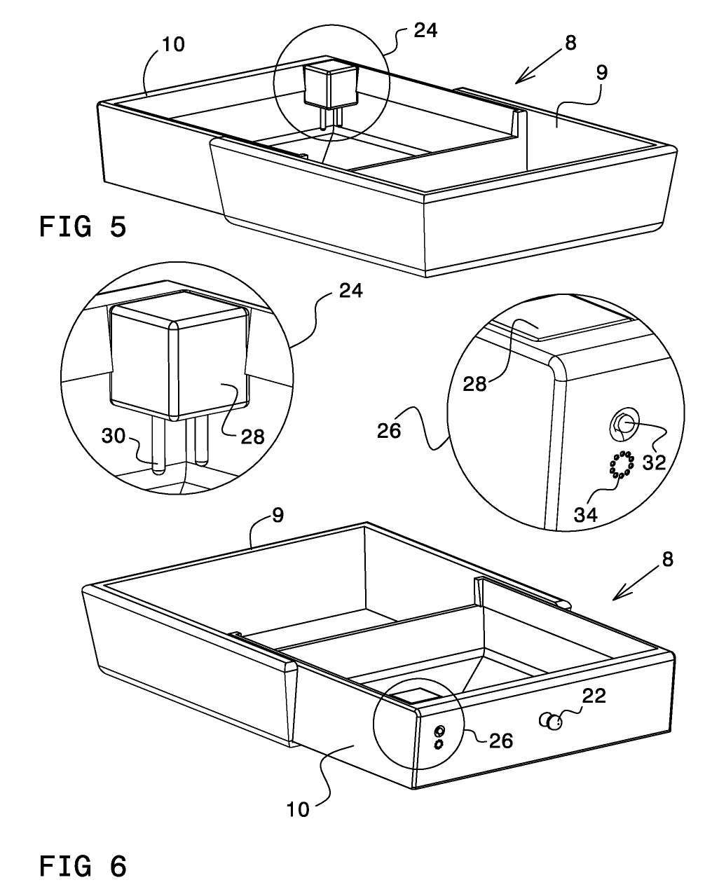

FIGS. 5 and 6 illustrate a saucer apparatus 8, according to one embodiment of the invention. FIG. 5 is a back view of the saucer apparatus 8, and FIG. 6 is a front view thereof. Each of numerals 24 and 26 is a zoomed view.

A water level sensor 28 is installed inside container 10. According to one embodiment of the invention, the water level is adapted to indicate if the water content falls below a predetermined level. According to another embodiment of the invention, the water level is adapted to indicate if the water level is higher than a predetermined level.

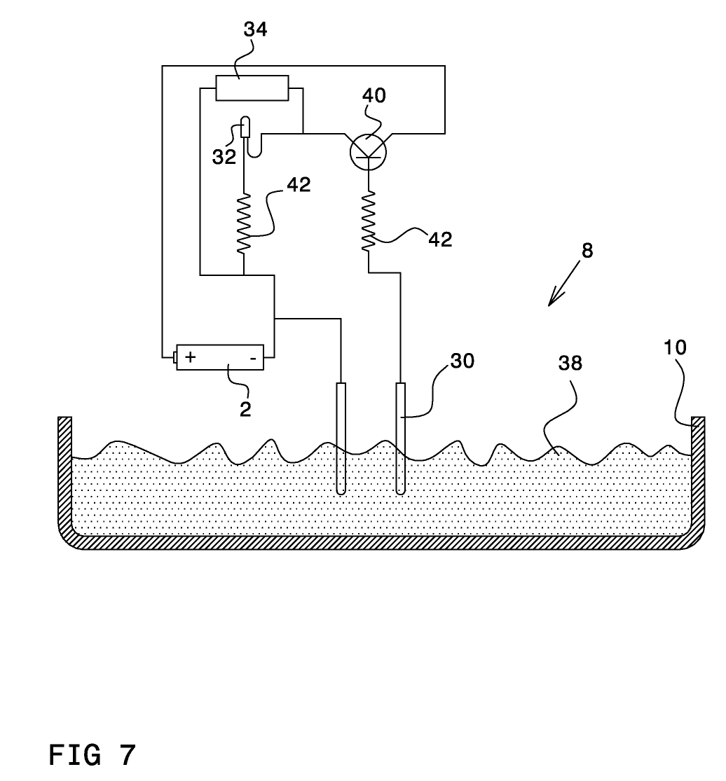

The water level sensor 28 comprises two electrodes 30, and a circuitry (such as the circuit illustrated in FIG. 7). When both electrodes 30 are dipped in water, an alarm signal may be triggered. Such an alarm signal may be of a buzzer 34, a LED (Light Emission Diode) 32, and so on.

FIG. 7 schematically illustrates a circuit for an irrigation system which makes use of a saucer apparatus, according to one embodiment of the invention.

Water is actually a resistor. Thus, if at least one of the diodes 30 is not dipped in water 38, resistance between the diodes is infinite, and when both electrodes 30 are dipped in water 38, resistance between electrodes 30 is less than infinite.

When both electrodes 30 are dipped in water 38, the signal between electrodes 30 is magnified by transistor 40, resulting in lighting LED 32, and also supplying to electric device 34 the required power for its operation.

The electric device 34 may be a buzzer, a water pump, and so on.

In the case in which device 34 is a water pump, it may use the drained water for re-irrigating the flora thereof, thereby recycling the water, or in other words, conserving water and decreasing the frequency with which the flora must be irrigated.

According to one embodiment of the invention, the sensor 28 indicates if drainage container 10 is substantially empty. This may be employed in an irrigation regime wherein the plant occupying flowerpot 6 is irrigated constantly.

According to another embodiment of the invention, sensor 28 indicates if drainage container 10 is substantially full. This may be employed in an irrigation regime wherein the plant occupying flowerpot 6 is irrigated intermittently. For example, once indicating that drainage container 10 is substantially full, the entire content of drainage container 10 is pumped out of it, and poured into soil container 12. Also, rather than allowing the water to spill out of the drainage container, the water is poured into the soil container.

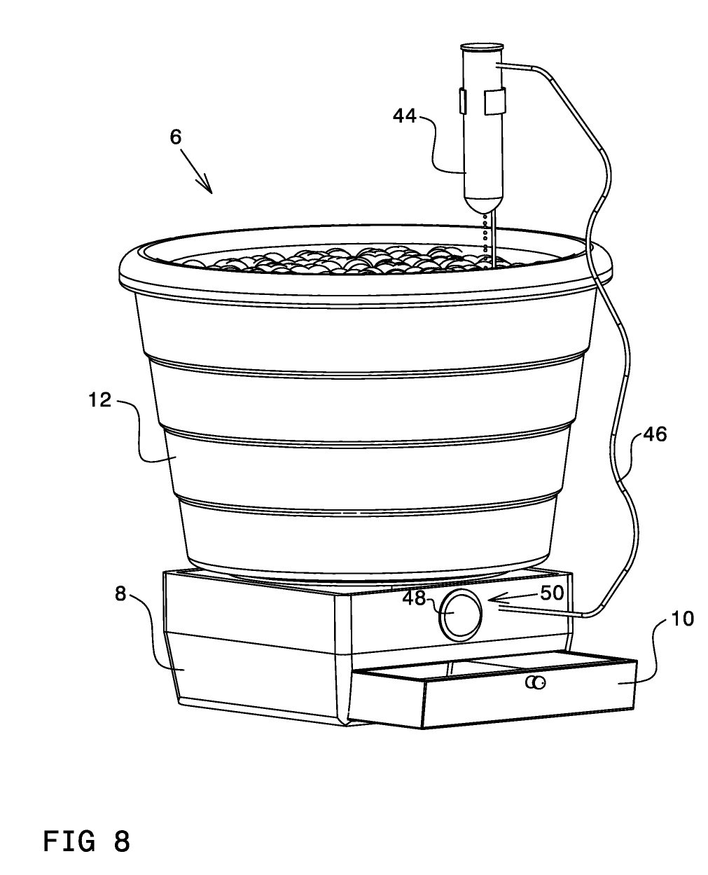

FIG. 8 illustrates a manual mechanism for recycling irrigation water from a saucer apparatus, according to one embodiment of the invention.

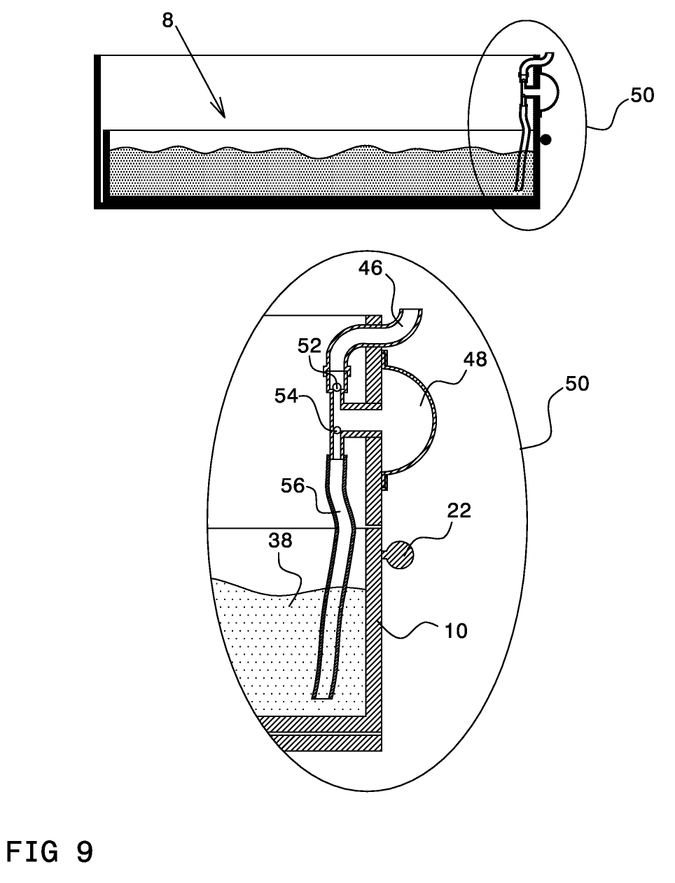

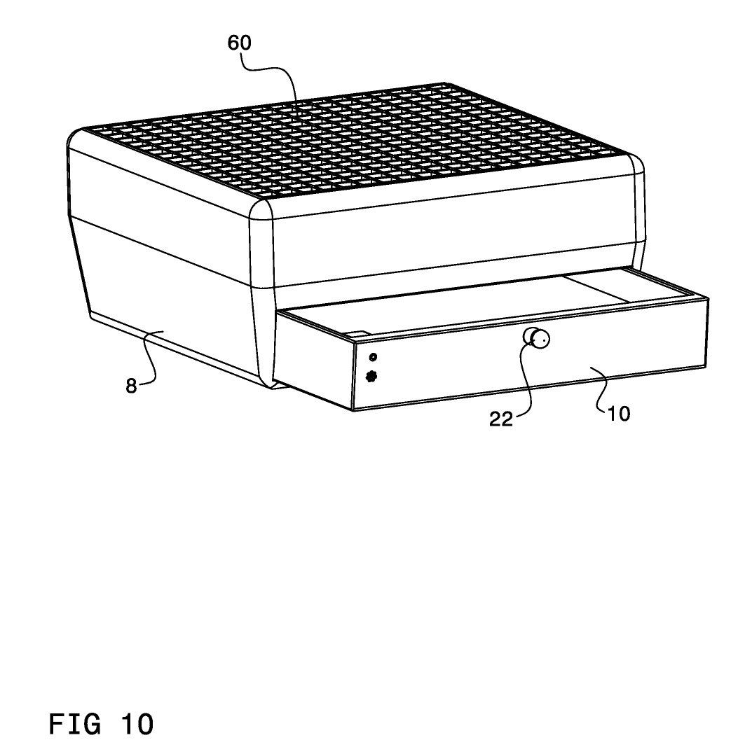

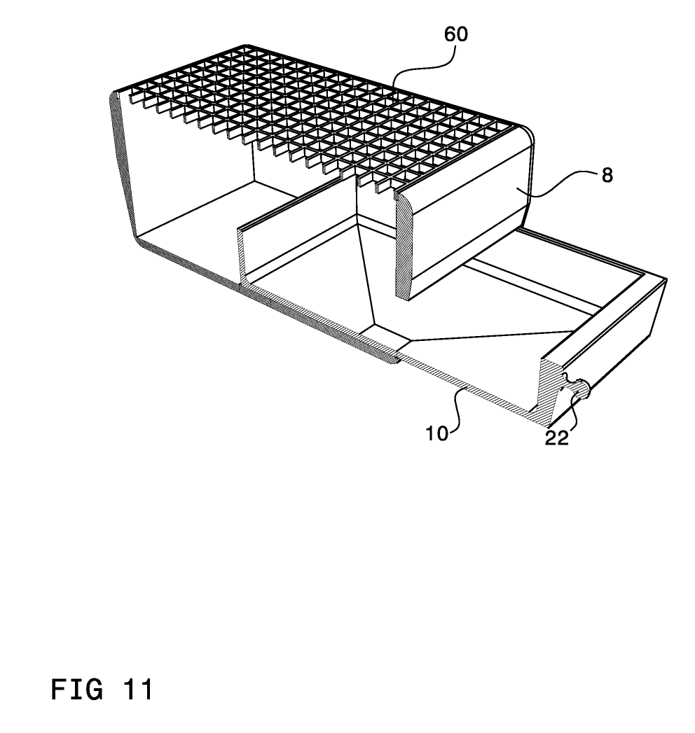

FIG. 9 is a cross-section which illustrates the structure of the mechanism illustrated in FIG. 8.

In these illustrations, a pump 48 is used for transferring the drained water accumulated in draining container 10, through tubule 46, to a container 44 which is placed above flowerpot 6, and allows the water to pour out of container 44 into the soil within flowerpot 6. Of course the mechanism may be employed without container 44, i.e., the upper end of tubule 46 may be placed on the soil within the flowerpot 6.

Numeral 50 denotes a zoomed view which schematically illustrates the pumping mechanism.

Numeral 48 denotes a rubber cup. When rubber cup 48 is pressed, valve 52 is lifted, allowing the water inside cup 48 to pass through tubule 46 to container 44. When rubber cup 48 is released, it returns to its “idle” form, which results in (a) lifting up valve 54, and (b) drawing water from container 10, through pipe 56, to fill the inside of cup 48.

The irrigating mechanism illustrated in FIGS. 8 and 9 may be used in a flowerpot irrigation method as follows: Assuming water is drained from the soil container 12 of the flowerpot into the container 10 of the saucer apparatus 8, upon indicating that the water level in the saucer apparatus 8 has reached a predetermined level, the accumulated water may be conveyed from container 10 of the saucer apparatus 8 into the soil container 12.

The predetermined level may indicate that the saucer apparatus is substantially empty, substantially full, and so on, depending on the selected level.

According to one embodiment of the invention, the act of conveying water from said saucer apparatus into said soil container may be carried out intermittently, i.e., once in a time period, such as once in two days, rather than continuously.

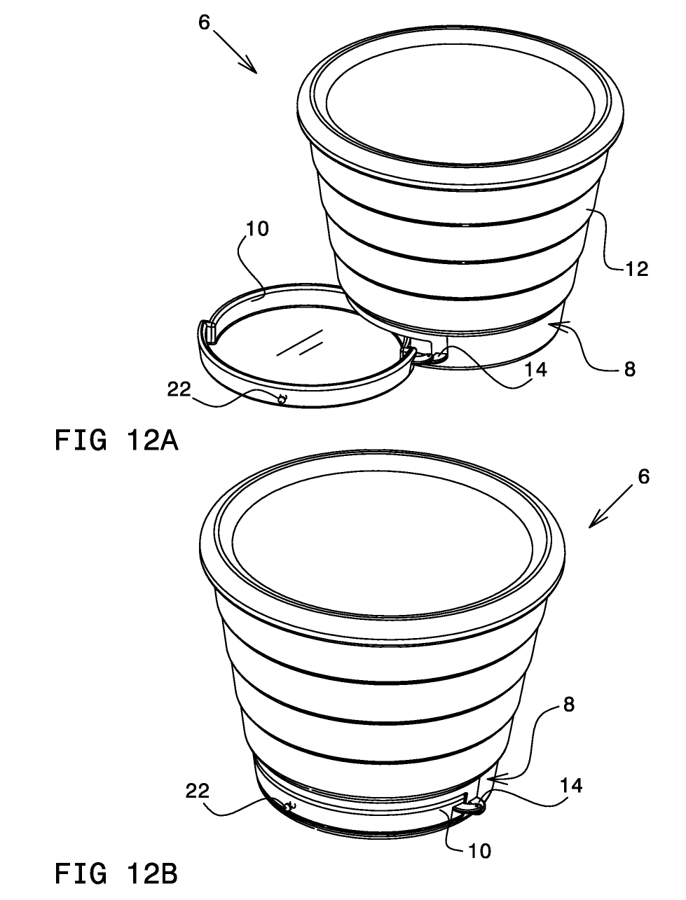

FIG. 10 schematically illustrates the lower side of a flowerpot, according to one embodiment of the invention, and FIG. 11 is a sectional view thereof.

According to this embodiment of the invention, apparatus 8 comprises a grill 60, on which a flowerpot may be placed. Apparatus 8 is designed as a stand, thereby allowing placement of flowerpots of varying sizes and designs. As such this is a preferred embodiment of the saucer apparatus 8.

Each of FIGS. 12a and 12b schematically illustrates a state of the drainage container of a flowerpot, according to another preferred embodiment of the invention. In these figures, the drawer 10 rotates along an axle 14, in contrast to the embodiments of FIGS. 1 to 6 in which movement is linear. As known to a skilled person in the art, rotational movement mechanism has some benefits over linear movement mechanism, simplicity in implementation being one of them. In FIG. 11a, the drawer 10 is pulled out of flowerpot 6, while in FIG. 11b the drawer is pushed into flowerpot 6.

### The Benefits of the Present Invention

In the prior art it is common to place a “giant” flowerpot on the saucer thereof. In this situation the accumulated water in the saucer is in contact with the roots of the plant thereof “too long”, and as a result the decay of the roots is accelerated, and accordingly the life of the plant shortens.

According to embodiments of the present invention, the water of the saucer underneath the flowerpot is not in contact with the flowerpot, and as a result the life of the plant lengthens.

According to embodiments of the present invention the user does not have to lift the flowerpot in order to remove the saucer underneath, but merely to pull the saucer out of the flowerpot, an operation which requires less physical effort.

Since according to embodiments of the present invention excess water in the saucer underneath a flowerpot is returned to the flowerpot, the drained water does not spill out. As such the flowerpot may be placed on a carpet as well as be hanged (e.g., on the ceiling).

Since according to embodiments of the present invention excess water is recycled, the amount of water required for irrigating the flowerpot is decreased, and also the cost of irrigating the flowerpot is decreased. In addition the frequency the flowerpot has to be irrigated is decreased, and therefore the effort thereof is decreased as well, e.g., irrigating the flora of the flowerpot once in ten days instead of once in a week.

### Parts List

In the figures and description herein, the following numerals have been mentioned:
Numeral 2 denotes an electric power source, such as a battery;
numeral 4 denotes a plant, flora, and so on.
numeral 6 denotes a flowerpot;
numeral 8 denotes the base of flowerpot 6;
numeral 9 denotes a housing of a saucer apparatus;
numeral 10 denotes a fetchable drainage container of flowerpot 6;
numeral 12 denotes a soil container of flowerpot 6;
numeral 14 denotes an axle;
numeral 20 denotes draining holes at the bottom of flowerpot 6;
numeral 22 denotes a handle for drawing draining container 10 out of base 8;
numeral 24 denotes a zoomed view;
numeral 26 denotes a zoomed view;
numeral 28 denotes a water level sensor;
numeral 30 denotes an electrode;
numeral 32 denotes a LED;
numeral 34 denotes an electric and/or electronic device;
numeral 38 denotes water;
numeral 40 denotes a transistor;
numeral 42 denotes a resistor;
numeral 44 denotes a container which is filled with recycled water, to be poured from its button into flowerpot 6;
numeral 46 denotes a tubule;
numeral 48 denotes a cup which is part of a pump;
numeral 50 denotes a zoomed view;
numeral 52 denotes a valve;
numeral 54 denotes a valve;
numeral 56 denotes a pipe; and
numeral 60 denotes a grill.

While certain features of the invention have been illustrated and described herein, the invention can be embodied in other forms, ways, modifications, substitutions, changes, equivalents, and so forth. The embodiments described herein should be considered as illustrative and not restrictive.

What is claimed is:

1. A flowerpot saucer apparatus, comprising:
a drainage container, for storing water drained from a soil container; and
a conveying mechanism, for conveying said drainage container from a first state in which said drainage container is deployed underneath said soil container, thereby allowing accumulating drained water, and a second state in which said drainage container is deployed apart of said soil container, thereby allowing emptying water stored in said drainage container, and vice versa.

2. An apparatus according to claim 1, wherein said soil container, is embedded into said apparatus.

3. An apparatus according to claim 1, further comprising means for holding said flowerpot above said apparatus.

4. An apparatus according to claim 1, further comprising means for holding said flowerpot on said apparatus.

5. An apparatus according to claim 4, wherein said means is a grill.

6. An apparatus according to claim 1, wherein said conveying mechanism conveys said drainage container linearly.

7. An apparatus according to claim 1, wherein said conveying mechanism conveys said drainage container rotationally.

8. An apparatus according to claim 1, wherein said conveying mechanism is based on a drawer conveying technology.

9. An apparatus according to claim 1, further comprising a water level sensor, for indicating the water level in said drainage container.

10. An apparatus according to claim 9, further comprising a sensor, for indicating if the water level in said drainage container exceeds a predetermined level.

11. An apparatus according to claim 9, further comprising a pump, for conveying drained water from said drainage container back into said soil container upon indicating that the water level in said drainage container has exceeded said predetermined level.

12. An apparatus according to claim 1, further comprising a pump, for conveying drained water from said drainage container back into said soil container.

13. An apparatus according to claim 12, wherein said pump is operated by mechanical power.

14. An apparatus according to claim 12, wherein said pump is operated by electric power.

15. A flowerpot irrigation method, the method comprising the steps of:
draining water from a soil container of said flowerpot into a saucer apparatus; and
upon indicating that the water level in said saucer apparatus has reached a predetermined level, conveying water from said saucer apparatus into said soil container.

16. A method according to claim 15, wherein said predetermined level indicates that said saucer apparatus is substantially empty.

17. A method according to claim 15, wherein said predetermined level indicates that said saucer apparatus is substantially full.

18. A method according to claim 15, wherein said conveying may be carried out intermittently.
